(19) United States
(12) Patent Application Publication
(10) Pub. No.: US 2026/0247295 A1
(43) Pub. Date: Aug. 20, 2026

(54) METHOD AND APPARATUS FOR SUPPORTING COMMUNICATION WITH CELLS OF DIFFERENT RADIO ACCESS TECHNOLOGIES

(71) Applicant: Nokia Technologies OY, Espoo (FI)

(72) Inventors: Mohamad Sayed HASSAN, Epinay sur-orge (FR); Daniela LASELVA, Klarup (DK); Iman HMEDOUSH, Massy (FR); Sankaran BALASUBRAMANIAM, Bangalore (IN)

(73) Assignee: Nokia Technologies OY, Espoo (FI)

(21) Appl. No.: 19/530,776

(22) Filed: Feb. 5, 2026

(30) Foreign Application Priority Data
Feb. 14, 2025 (IN) 202541012581

(51) Int. Cl. H04W 52/14; H04W 52/24

(52) U.S. Cl. CPC H04W 52/146; H04W 52/242

(57) ABSTRACT

A user equipment (UE) configured to support communication with a first cell using a first radio access technology and with a second cell using a second radio access technology different from the first radio access technology. The UE configured to receive, from a first network node associated with the first cell, configuration information for requesting cell access related information with respect to at least one of the first cell and the second cell, the first cell being controlled by the first network node and the second cell being controlled by a second network node; determine, based at least on the configuration information, uplink power for transmitting a first request message requesting the cell access related information with respect to the at least one of the first cell and the second cell; and transmit, to the first network node, the first request message using the determined uplink power.

### TECHNOLOGY

Various example embodiments relate to mobile or wireless telecommunication systems and, in particular, to systems and/or methods for communicating information elements with a user equipment (UE) for accessing radio access networks (RANs) via cells of different radio access technologies (RATs).

### BACKGROUND

Any discussion of the background art throughout the specification should in no way be considered as an admission that such art is widely known or forms part of common general knowledge in the field.

Multi-RAT Spectrum Sharing (MRSS) where spectrum sharing involves at least two Radio Access Technologies (RATs) sharing the same spectrum is increasingly important as new radio access technologies are developed. In particular, MRSS has been a key feature for the migration from 5G to 6G networks as it allows the New Radio (NR) and 6G cells to share the same carrier(s) dynamically adapting to traffic requirements. Especially for the standalone design for the 6G networks, MRSS is regarded as the most potential candidate to enable for the 5G-to-6G migration. In the MRSS scenario, it is assumed that the 5G and 6G cells share the same Radio Unit (RU), as illustrated in FIG. 1, where the same coverage is expected by the 5G MRSS cell and the 6G MRSS cell.

Another aspect regarding provision of information for accessing radio access networks (RANs), such as On-Demand (OD) System Information (SI), is currently under study in release-19 (Rel-19) proposals, which extends the on-demand SI procedures to be applied to System Information Block Type 1 (SIB1) that is broadcasted by a network node of a RAN, e.g., a base station (gNB), to provide essential system parameters and configuration information to a user equipment (UE) or devices in the network coverage area. Specifically, Rel-19 considers a multi-cell scenario for communication of the OD-SIB1 between a UE and multiple cells using various RATs. However, the resulting OD-SBI features according to the Rel-19 require additional switching processes between the UE and the individual cells.

In some circumstances there is a need for enhancing the efficiency in communication of information for accessing RANs (e.g., the OD-SIB1 procedure as mentioned above) in the context of the multi-cell scenario. In particular, it may be desirable to reduce the bandwidth- and energy-consumption both in user mobile devices and network systems and, at the same time, to ensure a smooth and cost-effective migration to the 6G networks.

### SUMMARY

The present disclosure relates in particular to apparatuses, systems and methods for an efficient provision of on-demand system information (e.g., OD-SIB1 procedure) for accessing one or more radio access networks in the MRSS scenario.

In accordance with a first aspect of the present disclosure, there is provided a User Equipment (UE) configured to support communication with a first cell using a first radio access technology and with a second cell using a second radio access technology different from the first radio access technology, the UE comprising:
at least one processor; and
at least one memory storing instructions that, when executed by the at least one processor, cause the UE at least to:
receive, from a first network node associated with the first cell, configuration information for requesting cell access related information with respect to at least one of the first cell and the second cell, the first cell being controlled by the first network node and the second cell being controlled by a second network node;
determine, based at least on the configuration information, uplink power for transmitting a first request message requesting the cell access related information with respect to the at least one of the first cell and the second cell; and
transmit, to the first network node, the first request message using the determined uplink power.

In some examples, the uplink power for transmitting the first request message is determined further based on at least one uplink power control parameter and/or at least one reference signal associated with the first and/or the second cell included in the configuration information.

In some examples, the uplink power for transmitting the first request message is determined based on a path loss for the first cell derivable from the configuration information.

In some examples, the uplink power for transmitting the first request message is determined based on a path loss for the first cell determined based on a first reference signal received from the first network node, and/or a second reference signal received from the second network node, as included in the configuration information.

In some examples, the first reference signal and the second reference signal comprise different transmitting power parameters or patterns. Accordingly, the UE is further caused to determine the path loss by at least one of the following:
selecting, as the path loss for determining the uplink power, a greater one of a first path loss determined based on the first reference signal and a second path loss determined based on the second reference signal,
determining an average path loss of the first path loss and the second path loss, and applying, based on a predefined rule included in the configuration information, a combining function to smooth the first path loss and the second path loss.

In some examples, the UE is further caused to receive the cell access related information with respect to the at least one of the first cell and the second cell. Optionally, the UE is further caused to transmit, to the second network node, a second request message requesting the cell access related information with respect to the at least one of the first cell and the second cell based on the configuration information.

In some examples, the cell access related information comprises a first type System Information Block (SIB1) of the first cell and/or the second cell, wherein the UE is further caused to receive, from the first network node, the SIB1 of at least one of the first cell and the second cell. Optionally, the UE is further caused to receive the SIB1 of at least one of the first cell and the second cell from the second network node.

In some examples, the first request message is a single request requesting the cell access related information with respect to the first cell and the second cell.

In some examples, the cell access related information comprises a difference of the SIB1 related to the first cell or the second cell. Accordingly, the UE is further caused to receive, from the first network node:
the SIB1 of the first cell or the difference of the SIB1 related to the first cell with respect to the second cell, or
the SIB1 of the first cell and the SIB1 of the second cell, or
the difference of the SIB1 related to the first cell with respect to the second cell and the SIB1 of the second cell.

In some examples, the UE is further caused to receive the SIB1 of the second cell from the second network node in case that the UE receives from the first network node the SIB1 of the first cell or the difference of the SIB1 related to the first cell with respect to the second cell.

In some examples, the configuration information comprises at least one of: at least one uplink power control parameter for transmitting the first request message, a set of downlink reference signals associated with the first and/or the second cell for uplink power control, resource information relating to Physical Random-Access Channel (PRACH) for transmitting the first request message, and information for monitoring transmissions of the cell access related information with respect to the first and/or the second cell.

In some examples, the configuration information comprises at least one of: a first dedicated configuration for requesting the SIB1 of the first network node, a second dedicated configuration for requesting the SIB1 of the second network node, and a shared configuration for requesting the SIB1 of the first network node and the SIB1 of the second network node.

In some examples, the configuration information comprises at least one of: a first configuration for requesting the cell access related information with respect to the first cell, a second configuration for requesting the cell access related information with respect to the second cell, and a third configuration for requesting the cell access related information with respect to the first cell and the second cell.

In some examples, at least one of the first configuration, the second configuration and the third configuration comprises at least one of the following:
at least one uplink power control parameter for transmitting the first request message,
a set of downlink reference signals associated with the first and/or the second cell for uplink power control,
resource information relating to Physical Random-Access Channel (PRACH) for transmitting the first request message, and
information for monitoring transmissions of the cell access related information with respect to the first and/or the second cell.

In some examples, optionally, the resource information comprises at least one PRACH preamble associated with the first request message requesting for at least one of the cell access related information with respect to the first cell, the cell access related information with respect to the second cell, and the cell access related information with respect to the first cell and the second cell.

In some examples, the first network node is associated with the first radio access technology and the second network node is associated with the second radio access technology, the first radio access technology sharing spectrum with the second radio access technology.

In some examples, the UE is further caused to identify the first cell based on a Synchronization Signal Block (SSB) transmitted from the first network node, and/or wherein the UE is further caused to select or re-select the first cell based on the SSB transmitted from the first network node.

In some examples, the configuration information comprises monitoring occasions for transmission of the cell access related information with respect to the first and/or the second cell. Accordingly, the UE is further caused to determine, based on the configuration information, common monitoring occasions for transmission of the cell access related information with respect to the first and the second cell in response to determination that the monitoring occasions for transmission of the cell access related information with respect to the first cell are aligned with the monitoring occasions for transmission of the cell access related information with respect to the second cell.

In some examples, the UE is further caused to receive the cell access related information with respect to the at least one of the first cell and the second cell in the determined common monitoring occasions.

In some examples, the configuration information comprises monitoring occasions for transmission of the cell access related information with respect to the first and/or the second cell. Accordingly, the UE is further caused to determine, based on the configuration information, the monitoring occasions for transmission of the cell access related information with respect to the first cell and/or the second cell, the monitoring occasions for transmission of the cell access related information with respect to the first cell are different than the monitoring occasions for transmission of the cell access related information with respect to the second cell.

In some examples, the UE is further caused to:
determine, based on the monitoring occasions for transmission of the cell access related information with respect to the first cell, the monitoring occasions for transmission of the cell access related information with respect to the second cell, or
determine, based on the monitoring occasions for transmission of the cell access related information with respect to the second cell, the monitoring occasions for transmission of the cell access related information with respect to the first cell.

In some examples, the UE is further caused to:
receive the cell access related information with respect to the first cell in the determined monitoring occasions for transmission of the cell access related information with respect to the first cell, and/or to receive the cell access related information with respect to the second cell in the determined monitoring occasions for transmission of the cell access related information with respect to the second cell.

In some examples, the monitoring occasions for transmission of the cell access related information with respect to the first and/or the second cell comprise Physical Downlink Control Channel (PDCCH) monitoring occasions for receiving a first type System Information Block (SIB1) of the first cell and/or the second cell.

In accordance with a second aspect of the present disclosure, there is provided a method of a User Equipment (UE) that supports communication with a first cell using a first radio access technology and with a second cell using a second radio access technology different from the first radio access technology, the method comprising:
receiving, from a first network node associated with the first cell, configuration information for requesting cell access related information with respect to at least one of the first cell and the second cell, the first cell being controlled by the first network node and the second cell being controlled by a second network node;
determining, based at least on the configuration information, uplink power for transmitting a first request message requesting the cell access related information with respect to the at least one of the first cell and the second cell; and
transmitting, to the first network node, the first request message using the determined uplink power.

In some examples, the first request message is a single request requesting the cell access related information with respect to the first cell and the second cell.

In accordance with a third aspect of the present disclosure, there is provided a computer program comprising instructions for causing an apparatus to perform the method according to the second aspect.

In accordance with a fourth aspect of the present disclosure, there is provided a memory storing computer readable instructions for causing an apparatus to perform the method according to the second aspect.

In accordance with a further aspect of the present disclosure, there is provided a User Equipment (UE) configured to support communication with a first cell using a first radio access technology and with a second cell using a second radio access technology different from the first radio access technology, the UE comprising: means for receiving, from a first network node associated with the first cell, configuration information for requesting cell access related information with respect to at least one of the first cell and the second cell, the first cell being controlled by the first network node and the second cell being controlled by a second network node;
means for determining, based at least on the configuration information, uplink power for transmitting a first request message requesting the cell access related information with respect to the at least one of the first cell and the second cell; and
means for transmitting, to the first network node, the first request message using the determined uplink power.

In addition, according to some other example embodiments, there is provided, for example, a computer program product for a wireless communication device comprising at least one processor, including software code portions for performing the respective steps disclosed in the present disclosure, when said product is run on the device. The computer program product may include a computer-readable medium on which said software code portions are stored. Furthermore, the computer program product may be directly loadable into the internal memory of the computer and/or transmittable via a network by means of at least one of upload, download and push procedures.

While some example embodiments will be described herein with particular reference to the above application, it will be appreciated that the present disclosure is not limited to such a field of use, and is applicable in broader contexts.

Notably, it is understood that methods according to the present disclosure relate to methods of operating the apparatuses according to the above example embodiments and variations thereof, and that respective statements made with regard to the apparatuses likewise apply to the corresponding methods, and vice versa, such that similar description may be omitted for the sake of conciseness. In addition, the above aspects may be combined in many ways, even if not explicitly disclosed. The skilled person will understand that these combinations of aspects and features/steps are possible unless it creates a contradiction which is explicitly excluded.

Implementations of the disclosed apparatuses may include using, but not limited to, one or more processor, one or more application specific integrated circuit (ASIC) and/or one or more field programmable gate array (FPGA). Implementations of the apparatus may also include using other conventional and/or customized hardware such as software programmable processors, such as graphics processing unit (GPU) processors.

Other and further example embodiments of the present disclosure will become apparent during the course of the following discussion and by reference to the accompanying drawings.

### BRIEF DESCRIPTION OF THE DRAWINGS

Example embodiments of the disclosure will now be described, by way of example only, with reference to the accompanying drawings in which:

FIG. 1 schematically illustrates an example of MRSS with 5G Standalone and 6G Standalone deployment;

FIG. 2(a) schematically illustrates an example of the OD-SIB1 procedure in the Non-Standalone case;

FIG. 2(b) schematically illustrates an example of the OD-SIB1 procedure in the Standalone (6G) case;

FIG. 3 schematically illustrates an exemplary signaling diagram for implementing OD-SIB1 procedure in the MRSS scenario based on a single WUS request for OD-5G and 6G OD-SIB1s according to an embodiment of the present disclosure;

FIG. 4 schematically illustrates an exemplary signaling diagram for implementing OD-SIB1 procedure in the MRSS scenario based on a single WUS configuration for OD-5G and OD-6G SIB1s according to an embodiment of the present disclosure;

FIG. 5(a) schematically illustrates an example of the UE's monitoring of the SIB1 transmission according to an embodiment of the present disclosure, with PDCCH monitoring for OD-SIB1 aligned between the 5G MRSS cell and the 6G MRSS cell;

FIG. 5(b) schematically illustrates an example of the UE's monitoring of the SIB1 transmission according to an embodiment of the present disclosure, with PDCCH monitoring for OD-SIB1 for the first RAT and Type0-PDCCH of the second RAT determined from Type0-PDCCH of the first RAT;

FIG. 6 schematically illustrates an exemplary signaling diagram for determining uplink power in the OD-SIB1 procedure according to an embodiment of the present disclosure;

FIG. 7 schematically illustrates an example of a signaling diagram for the Xn interface between the 5G network node and the 6G network node according to an embodiment of the present disclosure;

FIG. 8 illustrates an example of a method 800 of a UE in accordance with embodiments of the disclosure;

FIG. 9 illustrates an example of a method 900 of a UE in accordance with embodiments of the disclosure; and FIG. 10 illustrates an example of a method 1000 of a UE in accordance with embodiments of the disclosure.

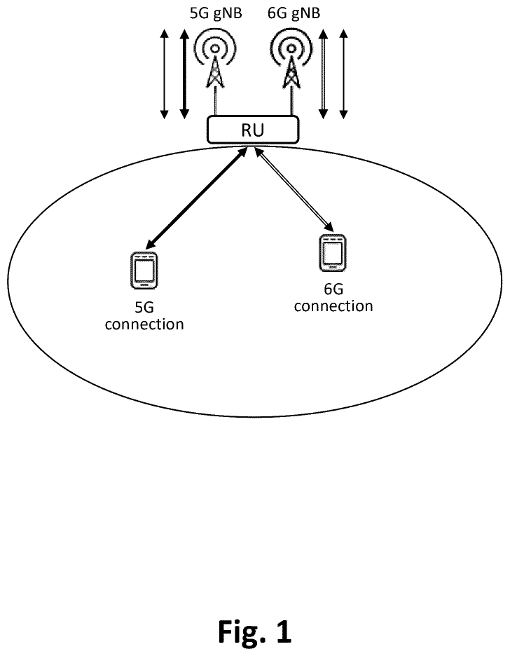

### DESCRIPTION OF EXAMPLE EMBODIMENTS

In the following, different exemplifying embodiments will be described using, as an example of a communication network to which examples of embodiments may be applied, a communication network architecture based on 3GPP standards for a communication network, such as a 5G/NR, without restricting the embodiments to such an architecture, however. It is apparent for a person skilled in the art that the embodiments may also be applied to other kinds of communication networks where mobile communication principles are integrated with a D2D (device-to-device) or V2X (vehicle to everything) configuration, such as SL (side link), e.g. Wi-Fi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network, but principles of the disclosure can be extended and applied to any other type of communication network, such as a wired communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules, etc., that have not been specifically mentioned.

A basic system architecture of a (tele)communication network including a mobile communication system where some examples of embodiments are applicable may include an architecture of one or more communication networks including wireless access network subsystem(s) and core network(s). Such an architecture may include one or more communication network control elements or functions, access network elements, radio access network elements, access service network gateways or base transceiver stations, such as a base station (BS), an access point (AP), a NodeB (NB), an eNB or a gNB, a distributed unit (DU) or a centralized/central unit (CU), which controls a respective coverage area or cell(s) and with which one or more communication stations such as communication elements or functions, like user devices or terminal devices, like a user equipment (UE), or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application on capable of conducting a communication, or the like, are capable to communicate via one or more channels via one or more communication beams for transmitting several types of data in a plurality of access domains. Furthermore, core network elements or network functions, such as gateway network elements/functions, mobility management entities, a mobile switching center, servers, databases and the like may be included.

The following description may provide further details of alternatives, modifications and variances: a gNB comprises e.g., a node providing NR user plane and control plane protocol terminations towards the UE, and connected via the NG interface to the 5GC, e.g., according to 3GPP TS 38.300 V16.6.0(2021-06) section 3.2 incorporated by reference.

A gNB Central Unit (gNB-CU) comprises e.g., a logical node hosting e.g., RRC, SDAP and PDCP protocols of the gNB or RRC and PDCP protocols of the en-gNB that controls the operation of one or more gNB-DUs. The gNB-CU terminates the F1 interface connected with the gNB-DU.

A gNB Distributed Unit (gNB-DU) comprises e.g., a logical node hosting e.g., RLC, MAC and PHY layers of the gNB or en-gNB, and its operation is partly controlled by the gNB-CU. One gNB-DU supports one or multiple cells. One cell is supported by only one gNB-DU. The gNB-DU terminates the F1 interface connected with the gNB-CU.

A gNB-CU-Control Plane (gNB-CU-CP) comprises e.g., a logical node hosting e.g., the RRC and the control plane part of the PDCP protocol of the gNB-CU for an en-gNB or a gNB. The gNB-CU-CP terminates the El interface connected with the gNB-CU-UP and the F1-C interface connected with the gNB-DU.

A gNB-CU-User Plane (gNB-CU-UP) comprises e.g., a logical node hosting e.g., the user plane part of the PDCP protocol of the gNB-CU for an en-gNB, and the user plane part of the PDCP protocol and the SDAP protocol of the gNB-CU for a gNB. The gNB-CU-UP terminates the El interface connected with the gNB-CU-CP and the F1-U interface connected with the gNB-DU, e.g., according to 3GPP TS 38.401 V16.6.0(2021-07) section 3.1 incorporated by reference.

Different functional splits between the central and distributed unit are possible, e.g., called options:
Option 1 (1A-like split):
   The function split in this option is similar to the 1A architecture in DC. RRC is in the central unit. PDCP, RLC, MAC, physical layer and RF are in the distributed unit.
Option 2 (3C-like split):
   The function split in this option is similar to the 3C architecture in DC. RRC and PDCP are in the central unit. RLC, MAC, physical layer and RF are in the distributed unit.
Option 3 (intra RLC split):
   Low RLC (partial function of RLC), MAC, physical layer and RF are in the distributed unit. PDCP and high RLC (the other partial function of RLC) are in the central unit.
Option 4 (RLC-MAC split):
   MAC, physical layer and RF are in the distributed unit. PDCP and RLC are in the central unit.
Or else, e.g., according to 3GPP TR 38.801 V14.0.0(2017-03) section 11 incorporated by reference.

A gNB supports different protocol layers, e.g., Layer 1 (L1)-physical layer.

The layer 2 (L2) of NR is split into the following sublayers: Medium Access Control (MAC), Radio Link Control (RLC), Packet Data Convergence Protocol (PDCP) and Service Data Adaptation Protocol (SDAP), where e.g.:
The physical layer offers to the MAC sublayer transport channels;
The MAC sublayer offers to the RLC sublayer logical channels;
The RLC sublayer offers to the PDCP sublayer RLC channels;
The PDCP sublayer offers to the SDAP sublayer radio bearers;
The SDAP sublayer offers to 5GC QoS flows;
Comp. refers to header compression and Segm. To segmentation;
Control channels include (BCCH, PCCH).

Layer 3 (L3) includes e.g., Radio Resource Control (RRC), e.g., according to 3GPP TS 38.300 V16.6.0(2021-06) section 6 incorporated by reference.

A RAN (Radio Access Network) node or network node like e.g. a gNB, base station, gNB CU or gNB DU or parts thereof may be implemented using e.g. an apparatus with at least one processor and/or at least one memory (with computer-readable instructions (computer program)) configured to support and/or provision and/or process CU and/or DU related functionality and/or features, and/or at least one protocol (sub-)layer of a RAN (Radio Access Network), e.g. layer 2 and/or layer 3.

The gNB CU and gNB DU parts may e.g., be co-located or physically separated. The gNB DU may even be split further, e.g., into two parts, e.g., one including processing equipment and one including an antenna. A Central Unit (CU) may also be called BBU/REC/RCC/C-RAN/V-RAN, O-RAN, or part thereof. A Distributed Unit (DU) may also be called RRH/RRU/RE/RU, or part thereof. Hereinafter, in various example embodiments of the present disclosure, the CU-CP (or more generically, the CU) may also be referred to as a (first) network node that supports at least one of central unit control plane functionality or a layer 3 protocol of a radio access network; and similarly, the DU may be referred to as a (second) network node that supports at least one of distributed unit functionality or the layer 2 protocol of the radio access network.

A gNB-DU supports one or multiple cells, and could thus serve as e.g., a serving cell for a user equipment (UE).

A user equipment (UE) may include a wireless or mobile device, an apparatus with a radio interface to interact with a RAN (Radio Access Network), a smartphone, an in-vehicle apparatus, an IoT device, a M2M (Machine-to-Machine) device, or else. Such UE or apparatus may comprise: at least one processor; and at least one memory including computer program code; wherein the at least one memory and the computer program code are configured to, with the at least one processor, cause the apparatus at least to perform certain operations, like e.g. RRC connection to the RAN. A UE is e.g., configured to generate a message (e.g., including a cell ID) to be transmitted via radio towards a RAN (e.g., to reach and communicate with a serving cell). A UE may generate and transmit and receive RRC messages containing one or more RRC PDUs (Packet Data Units).

The UE may have different states (e.g., according to 3GPP TS 38.331 V16.5.0(2021-06) sections 42.1 and 4.4, incorporated by reference).

A UE is e.g., either in RRC_CONNECTED state or in RRC_INACTIVE state when an RRC connection has been established.

In RRC_CONNECTED state a UE may:
store the AS context;
transfer unicast data to/from the UE;
monitor control channels associated with the shared data channel to determine if data is scheduled for the data channel;
provide channel quality and feedback information;
perform neighboring cell measurements and measurement reporting.

The RRC protocol includes e.g. the following main functions:
RRC connection control;
measurement configuration and reporting;
establishment/modification/release of measurement configuration (e.g. intra-frequency, inter-frequency and inter-RAT measurements);
setup and release of measurement gaps;
measurement reporting.

The general functions and interconnections of the described elements and functions, which also depend on the actual network type, are known to those skilled in the art and described in corresponding specifications, so that a detailed description thereof may omitted herein for the sake of conciseness. However, it is to be noted that several additional network elements and signaling links may be employed for a communication to or from an element, function or application, like a communication endpoint, a communication network control element, such as a server, a gateway, a radio network controller, and other elements of the same or other communication networks besides those described in detail herein below.

A communication network architecture as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage. Generally, a network function can be implemented either as a network element on a dedicated hardware, as a software instance running on a dedicated hardware, or as a virtualized function instantiated on an appropriate platform, e.g., a cloud infrastructure.

Furthermore, a network element, such as communication elements, like a UE, a terminal device, control elements or functions, such as access network elements, like a base station/BS, a gNB, a radio network controller, a core network control element or function, such as a gateway element, or other network elements or functions, as described herein, and any other elements, functions or applications may be implemented by software, e.g., by a computer program product for a computer, and/or by hardware. For executing their respective processing, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors. It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

The present disclosure generally seeks to provide a solution for efficient communication of cell access related information to a UE for accessing radio access networks (RANs) (e.g., the On-Demand System Information Block Type 1 (OD-SIB1) procedure) in the context of Multi-RAT Spectrum Sharing (MRSS), in order to allow for smooth migration to 6G network deployment.

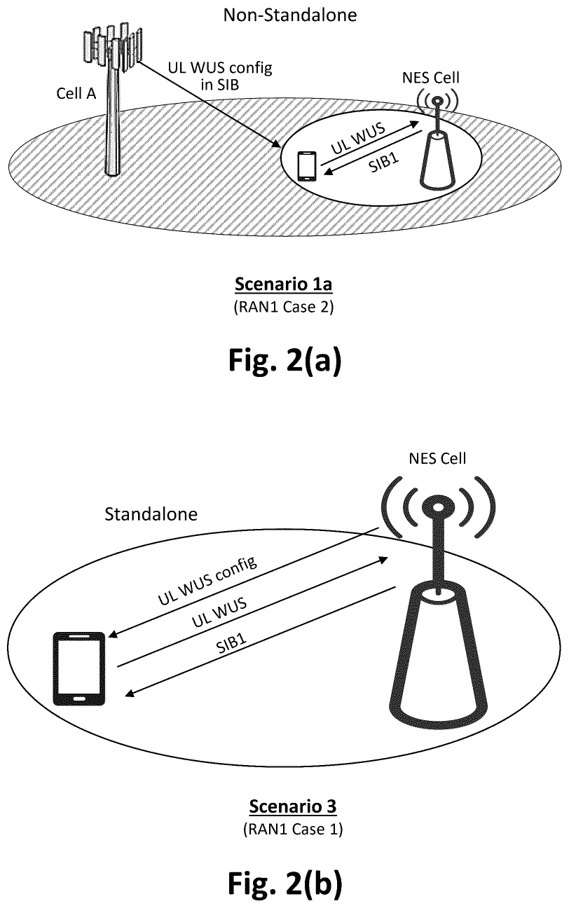

Rel-19 proposes the following cases shown in FIG. 2(a) and 2(b) as agreed in RAN1 and RAN2. For example, as illustrated in FIG. 2(a), a UE is assumed to be under the coverage of two cells: an anchor cell (referred to as cell A) and a capacity cell (referred to as Network Energy Savings (NES) cell). In the proposed multi-cell scenario, the capacity cell (referred in 3GPP as NES cell) operating with OD-SIB1 mode may not periodically broadcast the SIB1. Instead, the SIB1 of the cell may be provided on-demand, e.g., based on the UE in Radio Resource Control (RRC) idle or RRC inactive requesting its transmission. The UE may then trigger the transmission of the SIB1 by sending a wake-up signal (WUS), which may, for example, be a Physical Random-Access Channel (PRACH) i.e. a preamble. To this end, the UE may be configured with resources and information to transmit the WUS.

In the non-standalone case as illustrated in FIG. 2(a), it is considered the following processes:
UE obtains a WUS configuration from cell A;
UE sends an uplink (UL) WUS, i.e., a Random-Access Channel (RACH)/Random Access Preamble (Msg1), to NES cell;
UE monitors/receives a Random Access Response (RAR) from the cell that receives the WUS; and
UE receives OD-SIB1 from NES cell.

For 6G networks it is expected that the standalone case to be specified, as illustrated in FIG. 2(b). This case was assumed with large spec impact for 5G implementation due to Master Information Block (MIB) modification. In this case the UE communicates with the NES cell for obtaining the WUS configuration from the NES cell, sending the UL WUS to the NES cell and receiving the OD-SIB1 from the NES cell.

The present disclosure addresses the OD-SIB1 with MRSS by considering the following scenarios:

At a network node:
6G MRSS cell may operate in standalone OD-SIB1 mode;
5G MRSS cell may operate in non-standalone OD-SIB1 mode based on case 2 as agreed in Rel-19; and
(Optional) In MRSS scenario, 6G MRSS cell and 5G MRSS cell may have the same coverage.

At a UE:
6G UE (which may be backward compatible with 5G, i.e., supporting also 5G) may support both standalone and non-standalone modes for OD-SIB1; and
5G MRSS cell and 6G MRSS cell may be seen by a 6G UE as two candidate cells for re-selection.

However, the proposed OD-SIB1 solution based on Rel-19 has a drawback that the UE has to switch to another cell (e.g., other frequency layer) to receive the WUS configuration in order to request the on-demand SIB1 (for the NES cell). Switching is a major drawback that can be relaxed under the MRSS scenario. By the required switching processes, the UE oscillator/RF components need to switch to another frequency layer and the UE needs to re-select to and camp on another cell (e.g., referred to as cell A in FIG. 2(a)), to obtain the WUS configuration. Another drawback is that the network deployment needs to ensure that the UE under the NES cell shall be able to re-select to connect to another cell (e.g., the anchor cell referred to as cell A in FIG. 2(a)), in order to obtain the WUS configuration. Besides, deployment of multiple anchor cells (e.g., cell A in FIG. 2(a)) associated to one NES cell is expected despite the large Xn signaling overhead (which may be caused by the required inter-gNB exchange).

Accordingly, the present disclosure especially aims at exploiting the MRSS scenario to enable more efficient communication of cell access related information (especially e.g., the OD-SIB1 transmission) to a UE for accessing RANs using different RATs. Specifically, improved approaches are provided for implementing efficient OD-SIB1 procedure applicable in the MRSS scenario.

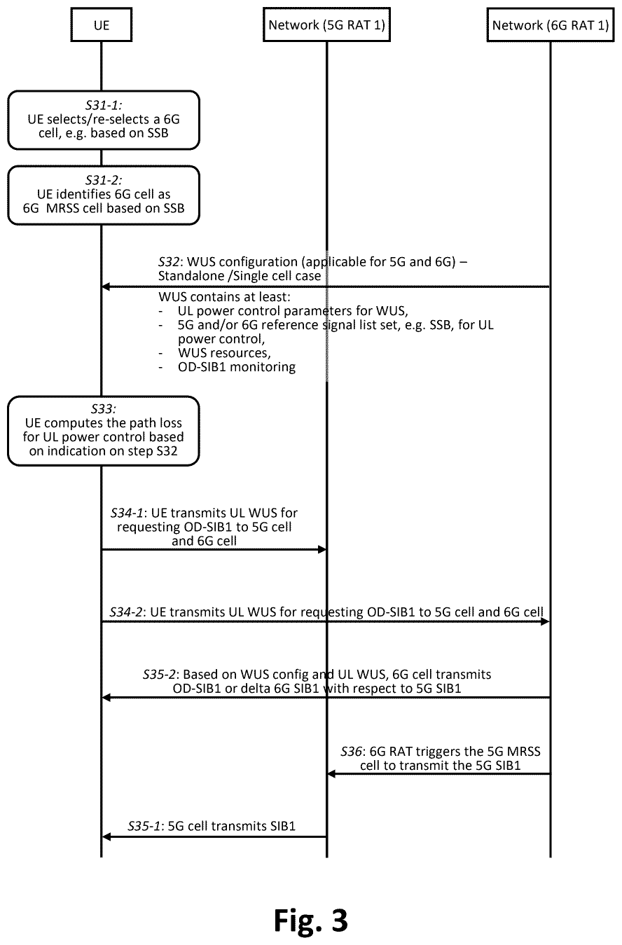

Practical examples of the proposed approaches for communication/transmission of cell access related information (e.g., the OD-SIB1 procedure) to solve the above indicated problems are illustrated in FIGS. 3 to 7 as described below, according to embodiments of the present disclosure. Although the following embodiments are provided referring explicitly to OD-SIB1 as an example, other types of information which can be used by a UE for accessing a radio access network is feasible and within the scope of the present disclosure.

References are now made to the figures. In particular, it is to be noted that identical or like reference numbers used in the figures of the present disclosure may, unless indicated otherwise, indicate identical or like elements, such that repeated description thereof may be omitted for reasons of conciseness.

### Unified/Single Request for Requesting 5G- and 6G-SIB1

FIG. 3 schematically illustrates an exemplary signaling diagram for implementing OD-SIB1 procedure in the MRSS scenario according to an embodiment of the present disclosure. In the MRSS scenario, the 5G network node (associated with the 5G cell) may share spectrum with the 6G network node (associated with the 5G cell). It is further noted that the 5G cell and the 6G cell may provide an overlapping coverage area for communication with the UE. In the embodiment as illustrated in FIG. 3, the OD-SIB1 procedure is based on a single WUS request for requesting 5G- and 6G-OD-SIB1s as carried out below.

At Step S31: the UE may select/re-select on a 6G cell, e.g., based on Synchronization Signal Block (SSB). In addition, the UE may also identify (e.g., based on SSB) that the 6G cell is a MRSS cell. It should be noted that, at this step, the UE may not acquire 5G SIB1 or 6G SIB1.

At Step S32: the UE may obtain the configuration information from the 6G cell (for example, whenever the 6G cell is working with standalone OD-SIB1) as 6G WUS configuration. The 6G WUS configuration may include, for example, uplink (UL) power control parameters for WUS (e.g., as a request message for requesting the SIB1), 5G and/or 6G downlink reference signal list set, e.g., SSB for uplink (UL) power control, WUS resources (e.g., resource information relating to Physical Random-Access Channel, PRACH) and OD-SIB1 monitoring information, etc. Thus, the UE may receive indication of the WUS power control parameters and other factors included in the WUS configuration for UL power control (e.g., for transmitting the request message).

At Step S33: the UE may compute the path loss for UL power control based on the indication at Step S32. However, this step is optional for determining optimal UL power.

At Step S34: the UE may transmit a single request for requesting OD-SIB1 of both 6G and 5G to the 6G cell (Step S34-2) or to the 5G cell (Step S34-1) using the WUS configuration received at Step 32. In particular, the single request may be transmitted using e.g., the UL power control parameters received in the WUS configuration.

At step S35: upon receiving the request from the UE, the 6G MRSS cell may transmit (Step S35-2) the 6G SIB1 or a delta 6G SIB1 (i.e., delta/difference towards the 5G SIB1) and trigger (Step S36) the 5G MRSS cell to transmit the 5G SIB1 (Step S35-1). Alternatively, upon receiving the UE request, the 6G MRSS cell may transmit both the 5G SIB1 and 6G SIB1, or the 5G SIB1 and a delta 6G SIB1 (delta/difference towards the 5G SIB1) to the UE, namely, the 5G SIB1 and 6G SIB1 may both be transmitted by one RAT (e.g., 6G cell).

Subsequently, the UE may assume, or may be configured with the monitoring occasions for OD-SIB1 which are aligned (the same) between the 5G MRSS cell and the 6G MRSS cell. In other cases, the UE may assume, or may be configured with the monitoring occasions for OD-SIB1 which are different between the 5G MRSS cell and the 6G MRSS cell. For example, the UE may monitor first the SIB1 transmission for 5G and later the SIB1 transmission for 6G, so that the UE may acquire first the 5G SIB1 and later the (delta) 6G SIB1.

It may be noted that the 5G cell and the 6G cell are expected to provide the same radio coverage in the MRSS scenario (i.e., the same radio unit may support the two MRSS cells, using the same frequency and same transmitter power and transmitter antenna for both technologies). Thus, it may be possible that the UE which selects the 5G cell as the strongest cell, measures the 6G cell as the second strongest cell and vice versa. The selection of the 6G cell over the 5G cell may be ensured by using RAT and frequency specific priorities (e.g., absolute priorities for cell reselection) to ensure that the 6G UEs prefers the 6G cell increasing the 6G network utilization. However, it may also be possible for the 6G UE to move to the 5G cell despite the presence of the 6G cell, for example, due to the lack of (optimized) support of certain services such as voice by 6G in initial deployments.

Accordingly, SIB 1s for both 5G and 6G cells can be acquired by using a single UE request. In this way, no cell switching by the UE (e.g., entailing UE oscillator/RF switching) between the MRSS cells is necessary. Depending on the use cases, pro-active approaches may be applied, for example, in cell re-selection when the UE attempts to switch from a MRSS cell using the first RAT (e.g., 6G) to another MRSS cell using the second RAT (e.g., 5G).

### Unified/Single Request of WUS Configuration for Requesting 5G- and 6G-SIB1

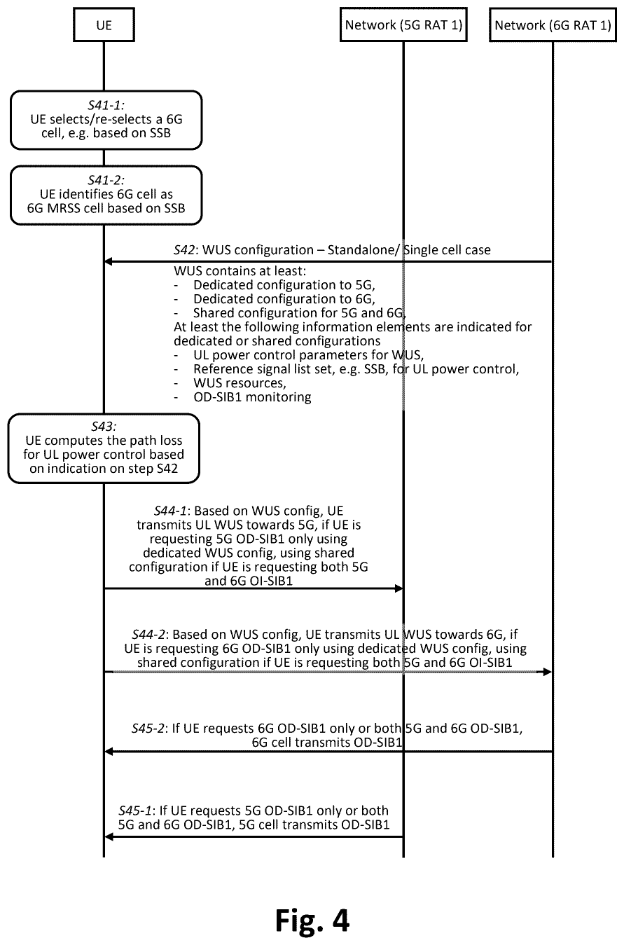

FIG. 4 schematically illustrates an exemplary signaling diagram for implementing OD-SIB1 procedure in the MRSS scenario according to an embodiment of the present disclosure. Similar to the embodiment of FIG. 3, the 5G network node (associated with the 5G cell) may share spectrum with the 6G network node (associated with the 5G cell), and the 5G cell and the 6G cell may provide an overlapping coverage area for communication with the UE. In the embodiment as illustrated in FIG. 4, the OD-SIB1 procedure is based on a single WUS configuration for requesting 5G- and 6G-OD-SIB1s as carried out below.

At Step S41: similar to Step S31, the UE may select/re-select on a 6G cell, e.g., based on SSB. In addition, the UE may also identify (e.g., based on SSB) that the 6G cell is a MRSS cell. It should be noted that, at this step, the UE may not acquire 5G SIB1 or 6G SIB1.

At Step S42: similar to Step S32, the UE may obtain WUS configuration from the 6G cell. The 6G cell may be working with standalone OD-SIB1. The WUS configuration, as a single configuration message, may include, for example, the 5G WUS configuration and 6G WUS configuration. For example, the WUS configuration may indicate that the WUS configuration is valid for the 5G cell only (i.e., dedicated configuration associated with the 5G cell), for both the 5G cell and the 6G cell (i.e., shared configuration associated with both the 5G and 6G cells), or for the 6G cell only (i.e., dedicated configuration associated with the 6G cell). In addition, different PRACH resources (time/frequency resource, preamble etc.) may be assigned to requesting the 5G cell only, the 5G cell and the 6G cell, or the 6G cell only. Besides, similar to the configuration information obtained at Step S32, the single configuration message may also contain information elements indicated for the dedicated or shared configurations such as uplink (UL) power control parameters for a respective WUS, a respective downlink reference signal list set, e.g., SSB for UL power control, respective WUS resources and OD-SIB1 monitoring information, etc.

At Step S43: the UE may compute the path loss for UL power control based on the indication at Step S42. For example, the UE may compute the UL power based on the path loss computed from a 5G SSB and/or a 6G SSB. Besides, the UE may assume the path loss computed based on the 5G SSB is also valid for the 6G SSB based on the indication provided in the WUS configuration received at Step S42. As indicated above, this step is optional for determining optimal UL power.

At Step S44: the UE may transmit a request for requesting OD-SIB1 for 5G cell or for 6G cell based on the indication received in the WUS configuration. For example, as indicated by Step S44-1, based on the WUS configuration, the UE may transmit the UL WUS towards the 5G cell using the dedicated WUS configuration if the UE requests the OD-SIB1 for 5G only, or using the shared configuration if the UE requests the OD-SIB1 for both 5G and 6G. Alternatively or additionally, as indicated by Step S44-2, based on the WUS configuration, the UE may transmit the UL WUS towards the 6G cell using the dedicated WUS configuration if the UE requests the OD-SIB1 for 6G only, or using the shared configuration if the UE requests the OD-SIB1 for both 5G and 6G. Accordingly, in the embodiment as shown in FIG. 4, a respective request may be transmitted to the corresponding cell (5G/6G) using e.g., the UL power control parameters received in the single WUS configuration.

At step S45: upon receiving the request(s) from the UE, the 5G and/or 6G MRSS cell may transmit SIB1 based on the received request(s). Specifically, the 5G MRSS cell may transmit (Step S45-1) the OD-SIB1 to the UE if the UE requests the OD-SIB1 for 5G only or the OD-SIB1 for both 5G and 6G. Alternatively or additionally, the 6G MRSS cell may transmit (Step S55-2) the OD-SIB1 to the UE if the UE requests the OD-SIB1 for 6G only or the OD-SIB1 for both 5G and 6G.

Similar to the embodiment of FIG. 3, the UE may subsequently assume, or may be configured with the monitoring occasions for OD-SIB1 which are aligned (the same) between the 5G MRSS cell and the 6G MRSS cell. In other cases, the UE may assume, or may be configured with the monitoring occasions for OD-SIB1 which are different between the 5G MRSS cell and the 6G MRSS cell (where the UE may, for example, monitor first the SIB1 transmission for 5G and later the SIB1 transmission for 6G, so that the UE may acquire first the 5G SIB1 and later the (delta) 6G SIB1). It is further appreciated that, depending on the use cases, a triggering event similar to Step S36 in the embodiment of FIG. 3 may also take place between the 5G cell and the 6G cell in the embodiment of FIG. 4.

Accordingly, the WUS configuration for both 5G and 6G MRSS cells can be provided by a single cell (e.g., by either the 6G cell or the 5G cell). Thus, no cell switching by the UE (e.g., UE oscillator/RF switching) between the MRSS cells is necessary. It is further noted that the 6G cell may act as an anchor cell for the 5G cell, and vice-versa. In this way, less UE power consumption may be expected as same monitoring occasions may be assumed for the SIB1 transmission by the MRSS cells using different RATs.

### Monitoring of OD-SIB1 Transmission

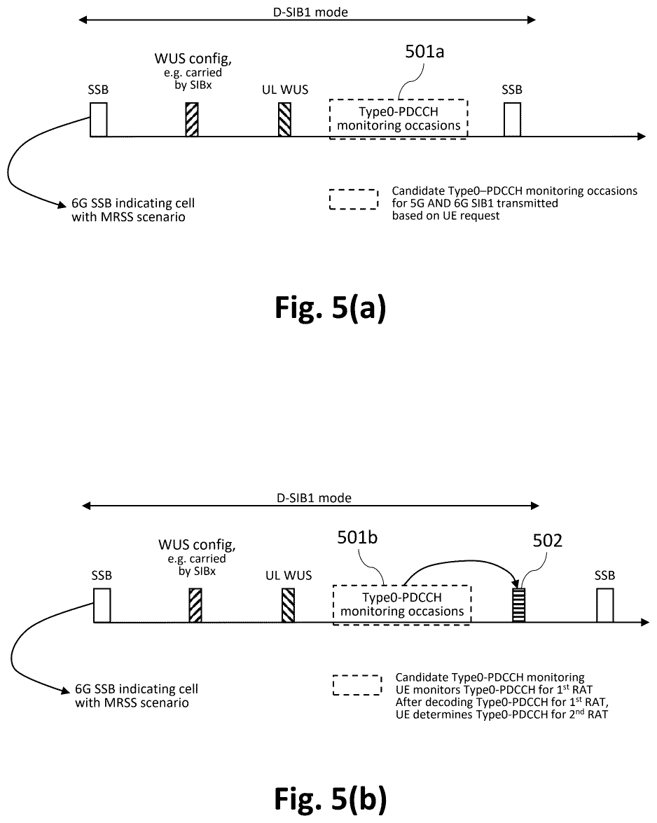

As indicated above, the UE may perform monitoring of the SIB1 transmission by the 5G and/or 6G cells based on the monitoring information included in the obtained configuration information/configuration message. FIG. 5(a) and 5(b) schematically illustrate examples of the UE's monitoring of the SIB1 transmission according to embodiments of the present disclosure. In particular, FIG. 5(a) illustrates the above mentioned case where the monitoring occasions for OD-SIB1 are aligned (the same) between the 5G MRSS cell and the 6G MRSS cell, while FIG. 5(b) illustrates the above mentioned case where the monitoring occasions for OD-SIB1 of the 5G MRSS cell and the 6G MRSS cell are different. Specifically, the monitoring occasions for transmission of the SIB1 with respect to the 5G and 6G cell may be, for example, Physical Downlink Control Channel (PDCCH) monitoring occasions. However, other types of monitoring occasions which can be used by a UE for monitoring transmission of cell access related information is feasible and within the scope of the present disclosure. It is further appreciated that the illustrated examples of FIG. 5 may be applicable in conjunction with the embodiment of FIG. 3 and the embodiment of FIG. 4 as described above.

In the example of FIG. 5(a) where the monitoring occasions for OD-SIB1 are aligned between the 5G MRSS cell and the 6G MRSS cell, a network node (associated with the 5G/6G cell) may configure the UE with monitoring occasions for Type0-PDCCH of OD-SIB1 for the 5G and/or 6G cell using the WUS configuration or Physical Broadcast Channel (PBCH) payload. Based on the network configuration, the UE may determine common monitoring occasions 501a for Type0-PDCCH of OD-SIB1 for the 5G and 6G cells. The UE may determine that the monitoring occasions for Type0-PDCCH of OD-SIB1 for 5G and 6G are aligned. The UE may then acquire in the determined common monitoring occasions the Type0-PDCCH of 5G OD-SIB1 and Type0-PDCCH of 6G OD-SIB1.

In the example of FIG. 5(b) where the monitoring occasions for OD-SIB1 are different between the 5G MRSS cell and the 6G MRSS cell, the UE may determine the monitoring occasions for Type0-PDCCH of OD-SIB1 of one cell (using the first RAT, e.g., 6G), and determine the monitoring occasions for Type0-PDCCH of OD-SIB1 of another cell (using the second RAT, e.g., 5G) one after the other. For example, the UE may determine the Type0-PDCCH of OD-SIB1 of one cell using the second RAT from the Type0-PDCCH of OD-SIB1 of another cell using the first RAT. In another example, the UE may determine the monitoring occasions for Type0-PDCCH of OD-SIB1 of one cell using the second RAT from monitoring occasions of Type0-PDCCH of OD-SIB1 of another cell using the first RAT. The example of FIG. 5(b) depicts that the UE may monitor the Type0-PDCCH for the first RAT, as indicated by 501b, and, after decoding the Type0-PDCCH for the first RAT, the UE may determine the Type0-PDCCH for the second RAT, as indicated by 502.

### Uplink Power Determination

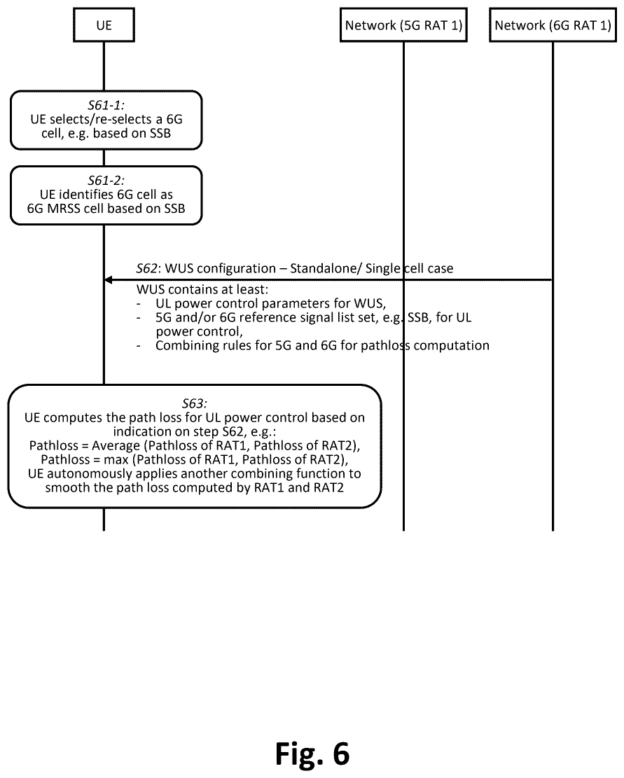

FIG. 6 schematically illustrates an exemplary signaling diagram for determining uplink power in the OD-SIB1 procedure according to an embodiment of the present disclosure. It is appreciated that the embodiment as illustrated in FIG. 6 may be applicable in conjunction with the embodiment of FIG. 3 (where a single WUS request is used for requesting 5G- and 6G-OD-SIB1s) and the embodiment of FIG. 4 (where a single WUS configuration is used for requesting 5G- and 6G-OD-SIB1s) as described above.

At Step S61: similar to S31 and S41, the UE may select/re-select on a 6G cell, e.g., based on Synchronization Signal Block (SSB). In addition, the UE may also identify (e.g., based on SSB) that the 6G cell is a MRSS cell. It should be noted that, at this step, the UE may not acquire 5G SIB1 or 6G SIB1.

At Step S62: similar to S32 and S42, the UE may obtain the configuration information from the 6G cell (for example, whenever the 6G cell is working with standalone OD-SIB1) as 6G WUS configuration. The 6G WUS configuration may also include, for example, uplink (UL) power control parameters for WUS (e.g., as a request message for requesting the SIB1), 5G and/or 6G downlink reference signal list set, e.g., SSB for UL power control. In the embodiment of FIG. 6, the 6G WUS configuration may further contain combining rules for 5G and 6G cells for path loss computation.

At Step S63: the UE may compute the path loss for UL power control based on the indication at Step S62. To transmit the UL WUS (e.g., a request for OD-SIB1) towards one cell, UE may measure the path loss of this cell and use the path loss in computing the transmitting power for the UL WUS. At Step S62, UE may measure the path loss for e.g., the 6G cell. Under the MRSS scenario, the UE may re-use the path loss computed based on the downlink reference signals of the 6G cell to compute the transmitting power of the UL WUS towards the 5G cell. Hence one single request can be transmitted towards the 5G and 6G cells based on the reference signals of the 6G cell.

However, if the transmitting power or pattern of the reference signals of the 6G cell is different than that of the 5G cell, the following implementations can be applied at the UE to achieve power control for the UL WUS:
For example, the UE may compute the UL path loss based on the (downlink) reference signals of one cell using the first RAT (RAT1) and the (downlink) reference signals of another cell using the second RAT (RAT 2). Accordingly, the UE may be signaled or not to apply one or more of the following:
   Path loss=Max {Path loss of RAT1, Path loss of RAT2} for power control of UL WUS;
   Path loss=Average {Path loss of RAT1, Path loss of RAT2} for power control; and
   The UE may apply another combining function (e.g., included in the WUS configuration) to smooth the path loss computed by RAT1 and RAT2.

Accordingly, the UE may compute the path loss based on the configured reference signal. Based on the measured path loss and based on the configured maximum output power and other parameters such as PRACH target received power, the UE may compute the PRACH transmitting power as described above. In this way, different downlink reference signals for different RATs may be configured and the UE may be requested to measure the path loss based on the configured reference signals of different RATs. The proposed solution further enables UL power control for PRACH taking into account the pathloss information as acquired from the WUS configuration(s).

It is appreciated that the (downlink) reference signal may be used for path loss computation (for UL power control). In the MRSS scenario for OD-SIB and UE switching between the 5G and 6G cells, the proposed solution according to the present disclosure exploits that the pathloss computation performed by one RAT is still valid for a second RAT. The path loss computation may then be used for determining the PRACH power (for transmitting the WUS) to request the OD-SIB1 from the 5G and/or 6G network nodes.

### Xn Interface Between 5G RAN and 6G RAN

In relation to the embodiments given in FIGS. 3 and 4 as described above, the Xn interface between the 5G network node (associated with the 5G MRSS cell) and the 6G network node (associated with the 6G MRSS cell) may support the following functions:
For the embodiment of FIG. 3 where a single WUS request is used for requesting 5G- and 6G-OD-SIB1s, the 6G MRSS cell may transmit both 5G SIB1 and 6G SIB1, or 5G SIB1 and delta 6G SIB1, or 5G SIB1 and delta 6G SIB1 and trigger the 5G MRSS cell to transmit 5G SIB1. Besides, the 6G MRSS cell may further transmit one WUS configuration for both 5G and 6G cells.
For the embodiment of FIG. 4 where a single WUS configuration is used for requesting 5G- and 6G-OD-SIB1s, the 6G MRSS cell may transmit both 5G and 6G WUS configuration (included in a (single) configuration message/information).

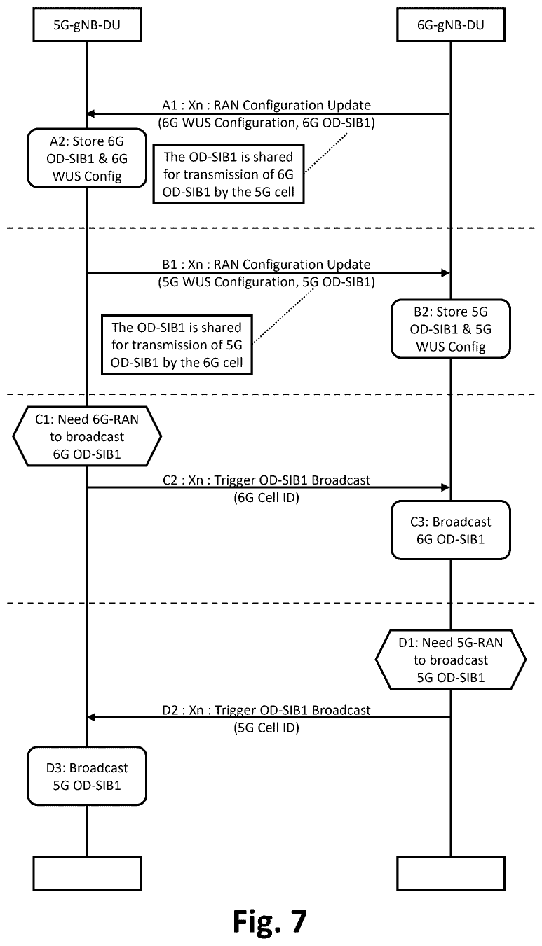

Accordingly, the support of the Xn interface between the 5G network node and 6G network node may include sharing of 5G SIB1 and 6G SIB1 between the RATs (e.g., the 6G and 5G cells) and triggering of one RAT by another RAT (e.g., the 6G cell triggering the 5G cell to transmit the 5G SIB1). In more detail, FIG. 7 schematically illustrates an example of a signaling diagram for the Xn interface between the 5G network node and the 6G network node according to an embodiment of the present disclosure.

At Step A1, the 6G RAN (controlled by the 6G cell, e.g., the 6G-gNB-DU) may share its WUS configuration and/or OD-SIB1 to the 5G RAN (controlled by the 5G cell, e.g., the 5G-gNB-DU). At Step A2, the 5G RAN may store the 6G WUS configuration and/or OD-SIB1 for broadcasting to the UEs (in connection with the 5G RAN). Similar, at Steps B1 and B2, the 5G RAN may share its WUS configuration and/or OD-SIB1 to the 6G RAN, which may store the same and use in its broadcast to its UEs. It should be noted that the activation of the OD-SIB1 feature may be either implicit or explicit. In the implicit case, when the WUS configuration is sent from one RAT to the other, the OD-SIB1 may be assumed to be activated (i.e., based on the WUS configuration). On the other hand, the OD-SIB1 feature may be explicitly activated by involving an additional Xn signaling (in addition to the WUS configuration) to activate (or deactivate) the OD-SIB1 feature.

Subsequently, at Steps C1 to C3, the 5G RAN may trigger the 6G RAN to broadcast the 6G OD-SIB1 which may execute the same request (as for requesting the 5G OD-SIB1). Similarly, at Steps D1 to D3, the 6G RAN may trigger the 5G RAN to broadcast the 5G OD-SIB1 which may execute the same request (as for requesting the 6G OD-SIB1).

It should be noted that the Xn interface as illustrated in FIG. 7 explicitly depicts the Xn signaling between two DUs, which shall however not be limited to signaling exchanges between the DUs. In some practical implementations, the actual interface may be directly setup between the 5G and 6G DUs, or may be through the respective CUs, based on the 3GPP decision on the inter-RAT interface.

In embodiments according to the present disclosure, the on-demand signal in 6G networks may be assumed to be e.g., a PRACH preamble. For example, a common PRACH preamble for both 5G and 6G RATs may be considered for the OD-SIB1. Using this common preamble, the UE may transmit Msg1 (the PRACH preamble) and the corresponding network node(s) may interpret this request as the OD-SIB1 for both 5G and 6G cells.

As described in the embodiment of FIG. 4, a user equipment identifying a 6G cell as 6G MRSS cell (e.g., based on 6G SSB) may assume the WUS configuration provided by the 6G cell is also valid for requesting the 5G MRSS SIB1 from either the 6G or 5G cell. That is, either the 6G network node or the 5G network node may transmit the WUS configuration for requesting the 5G SIB1 and/or the 6G SIB1. Assuming that the 5G cell may be the cell receiving the WUS request for the 5G SIB1 and/or the 6G SIB1, the 5G cell may receive the request for requesting the SIB1 of 6G cell and/or 5G cell. The 5G cell may transmit the 5G OD-SIB1 and/or the 6G OD-SIB1 based on the received request.

As described in the embodiment of FIG. 3, the 6G network node or the 5G network node may transmit the WUS configuration for the 5G cell and 6G cell. Assuming that the 5G cell may be the cell receiving the WUS request for OD-SIB1 for the 5G cell and the 6G cell, the 5G cell may receive the request for requesting the SIB1 of 6G cell and 5G cell. The 5G cell may transmit the 5G OD-SIB1 and trigger the 6G cell to transmit the 6G OD-SIB1, or transmit the 5G SIB1 and the 6G delta SIB1, or transmit the 5G SIB1 and the 6G SIB1.

Moreover, as described above, a user equipment requesting OD-SIB1 from the 6G cell, may consider that the monitoring occasions (monitoring window) for the 6G OD-SIB1 are the same as those for the 5G OD-SIB1. Furthermore, a user equipment may also compute the path loss for UL power control (e.g., Random Access Channel (RACH)) based on either the 5G SSB or the 6G SSB as configured in the WUS configuration.

It is appreciated that the proposed solution may allow for requesting cell access related information based on a single request sent from the UE. According to the present disclosure, a single request is defined for requesting SIB1 from both 6G cell and 5G cell. In this way, no or reduced cell switching by the UE (e.g., UE oscillator/RF switching) between MRSS cells is needed for requesting SIB1 from the 5G cell and the 6G cell.

It is further appreciated that, as explicitly illustrated in the above described embodiments, the 6G cell provides the WUS configuration to the UE (acting as an anchor), and the UE transmits to 6G cell the on-demand request to the 6G cell to acquire the SIB1 of 6G cell and 5G cell. However, in other cases, the 5G cell may act as an anchor cell as well.

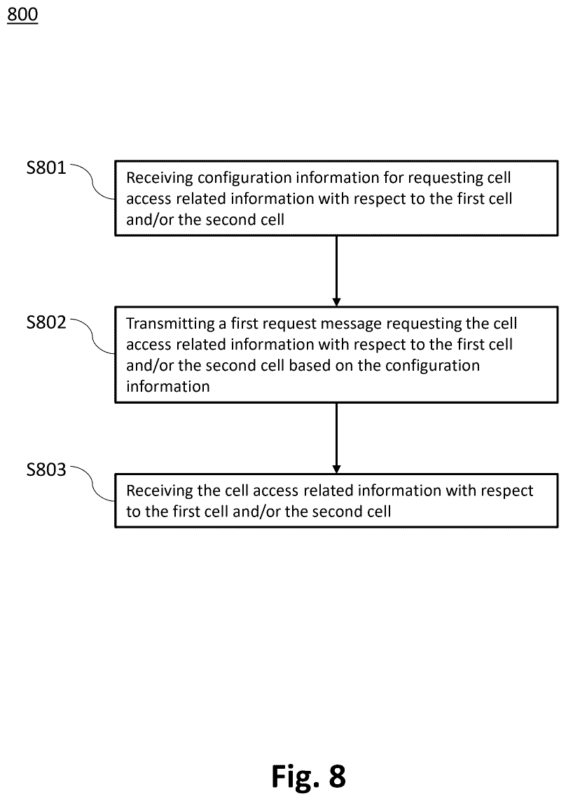

FIG. 8 illustrates an example of a method 800 of a UE that supports communication with a first cell using a first radio access technology and with a second cell using a second radio access technology in accordance with embodiments of the disclosure. Specifically, the second radio access technology may be different from the first radio access technology, and the first cell and the second cell may provide an overlapping coverage area for communication with the UE. Method 800 can be performed by any suitable device/apparatus (e.g., mobile devices, computers, etc.) comprising any suitable means for performing method 800. In particular, method 800 may be implemented during communications between the UE and a network node of one or more radio access networks (e.g., the 5G and/or 6G network nodes) in accordance with configuration information, as described in e.g., the embodiments of FIGS. 3, 4 and 6.

At step S801, method 800 comprises receiving, from a first network node (e.g., a 6G network node) associated with the first cell, configuration information for requesting cell access related information (e.g., SIB1 as described above) with respect to the first cell and/or the second cell. In particular, the first cell may be controlled by the first network node and the second cell may be controlled by a second network node (e.g., a 5G network node).

At step S802, method 800 comprises transmitting, to the first network node, a first request message requesting the cell access related information with respect to the first cell and/or the second cell based on the received configuration information.

At step S803, method 800 comprises receiving the cell access related information with respect to the first cell and/or the second cell.

It is noted that, as explicitly illustrated in the embodiment of FIG. 3, the method may receive configuration information for requesting cell access related information with respect to the first cell and the second cell (at step S801), transmit a first request message (i.e., a single request) requesting the cell access related information with respect to the first cell and the second cell (at step S802), and receive the cell access related information with respect to the first cell and the second cell (at step S803).

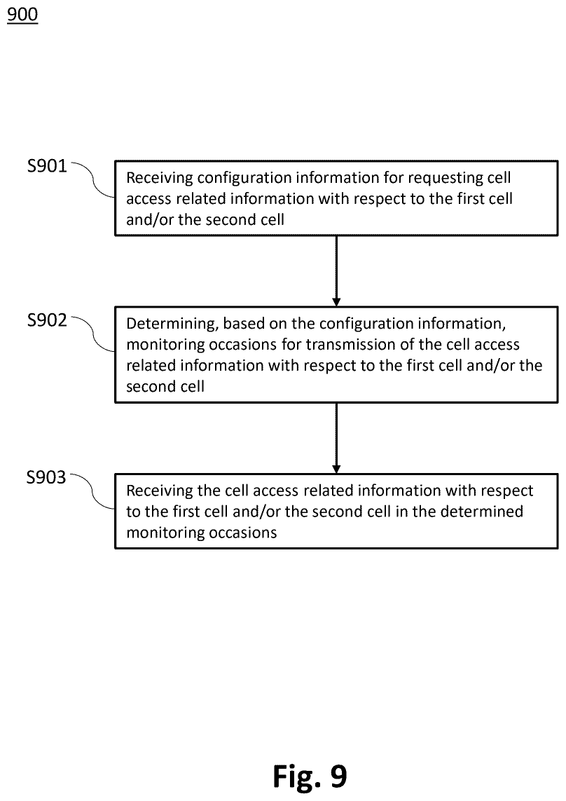

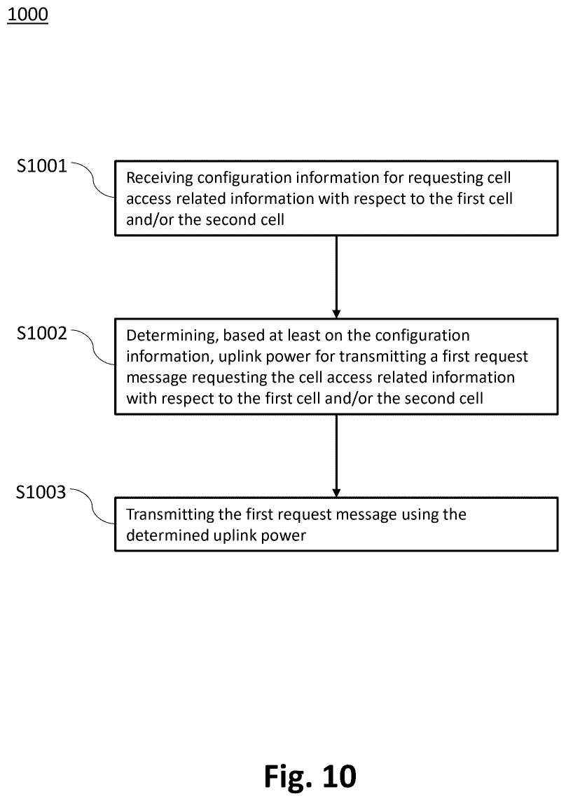

FIG. 9 illustrates an example of a method 900 of a UE that supports communication with a first cell using a first radio access technology and with a second cell using a second radio access technology in accordance with embodiments of the disclosure. Specifically, the second radio access technology may be different from the first radio access technology, and the first cell and the second cell may provide an overlapping coverage area for communication with the UE. Method 900 can be performed by any suitable device/apparatus (e.g., mobile devices, computers, etc.) comprising any suitable means for performing method 900. In particular, method 900 may be implemented during communications between the UE and a network node of one or more radio access networks (e.g., the 5G and/or 6G network nodes) in accordance with configuration information, as described in e.g., the embodiments of FIGS. 3 to 6.

At step S901, method 900 comprises receiving, from a first network node (e.g., a 6G network node) associated with the first cell, configuration information for requesting cell access related information (e.g., SIB1 as described above) with respect to the first cell and/or the second cell. In particular, the first cell may be controlled by the first network node and the second cell may be controlled by a second network node (e.g., a 5G network node).

At step S902, method 900 comprises determining, based on the configuration information, monitoring occasions for transmission of the cell access related information with respect to the first cell and/or the second cell.

At step S903, method 900 comprises receiving the cell access related information with respect to the first cell and/or the second cell in the determined monitoring occasions.

It is noted that, as explicitly illustrated in the embodiment of FIG. 3, the method may receive configuration information for requesting cell access related information with respect to the first cell and the second cell (at step S901), determine monitoring occasions for transmission of the cell access related information with respect to the first cell and the second cell (at step S902), and receive the cell access related information with respect to the first cell and the second cell in the determined monitoring occasions (at step S903).

FIG. 10 illustrates an example of a method 1000 of a UE that supports communication with a first cell using a first radio access technology and with a second cell using a second radio access technology in accordance with embodiments of the disclosure. Specifically, the second radio access technology may be different from the first radio access technology, and the first cell and the second cell may provide an overlapping coverage area for communication with the UE. Method 1000 can be performed by any suitable device/apparatus (e.g., mobile devices, computers, etc.) comprising any suitable means for performing method 1000. In particular, method 1000 may be implemented during communications between the UE and a network node of one or more radio access networks (e.g., the 5G and/or 6G network nodes) in accordance with configuration information, as described in e.g., the embodiments of FIGS. 3, 4 and 6.

At step S1001, method 1000 comprises receiving, from a first network node (e.g., a 6G network node) associated with the first cell, configuration information for requesting cell access related information (e.g., SIB1 as described above) with respect to the first cell and/or the second cell. In particular, the first cell may be controlled by the first network node and the second cell may be controlled by a second network node (e.g., a 5G network node).

At step S1002, method 1000 comprises determining, based at least on the configuration information, uplink power for transmitting a first request message requesting the cell access related information with respect to the first cell and/or the second cell.

At step S1003, method 1000 comprises transmitting, to the first network node, the first request message using the determined uplink power.

It is noted that, as explicitly illustrated in the embodiment of FIG. 3, the method may receive configuration information for requesting cell access related information with respect to the first cell and the second cell (at step S1001), and determine uplink power for transmitting a first request message requesting the cell access related information with respect to the first cell and the second cell (at step S1002).

It is noted that, although in the above-illustrated example embodiments (with reference to the figures), the messages communicated/exchanged between the network components/elements may appear to have specific/explicit names, depending on various implementations (e.g., the underlining technologies), these messages may have different names and/or be communicated/exchanged in different forms/formats, as can be understood and appreciated by the skilled person.

According to some example embodiments, there are also provided corresponding methods suitable to be carried out by the apparatuses (network elements/components) as described above, such as the UE, the CU, the DU, etc.

It should nevertheless be noted that the apparatus (device) features described above correspond to respective method features that may however not be explicitly described, for reasons of conciseness. The disclosure of the present document is considered to extend also to such method features. In particular, the present disclosure is understood to relate to methods of operating the devices described above, and/or to providing and/or arranging respective elements of these devices.

Further, according to some further example embodiments, there is also provided a respective apparatus (e.g., implementing the UE, the CU, the DU, etc., as described above) that comprises at least one processing circuitry, and at least one memory for storing instructions to be executed by the processing circuitry, wherein the at least one memory and the instructions are configured to, with the at least one processing circuitry, cause the respective apparatus to at least perform the respective steps as described above.

Yet in some other example embodiments, there is provided a respective apparatus (e.g., implementing the UE, the CU, the DU, etc., as described above) that comprises respective means configured to at least perform the respective steps as described above.

It is to be noted that examples of embodiments of the disclosure are applicable to various different network configurations. In other words, the examples shown in the above described figures, which are used as a basis for the above discussed examples, are only illustrative and do not limit the present disclosure in any way. That is, additional further existing and proposed new functionalities available in a corresponding operating environment may be used in connection with examples of embodiments of the disclosure based on the principles defined.

It should also to be noted that the disclosed example embodiments can be implemented in many ways using hardware and/or software configurations. For example, the disclosed embodiments may be implemented using dedicated hardware and/or hardware in association with software executable thereon. The components and/or elements in the figures are examples only and do not limit the scope of use or functionality of any hardware, software in combination with hardware, firmware, embedded logic component, or a combination of two or more such components implementing particular embodiments of the present disclosure.

It should further be noted that the description and drawings merely illustrate the principles of the present disclosure. Those skilled in the art will be able to implement various arrangements that, although not explicitly described or shown herein, embody the principles of the present disclosure and are included within its spirit and scope. Furthermore, all examples and embodiment outlined in the present disclosure are principally intended expressly to be only for explanatory purposes to help the reader in understanding the principles of the proposed method. Furthermore, all statements herein providing principles, aspects, and embodiments of the present disclosure, as well as specific examples thereof, are intended to encompass equivalents thereof.

### LIST OF ABBREVIATIONS

UE User equipment
RRC Radio Resource Control
MAC medium access control
BBU Baseband Unit
REC Radio Equipment Controller
RCC Radio Cloud Center?
C-RAN Cloud Radio Access Network
V-RAN Virtualized RAN
O-RAN Open RAN

1. A User Equipment, UE, configured to support communication with a first cell using a first radio access technology and with a second cell using a second radio access technology different from the first radio access technology, the UE comprising:
at least one processor; and
at least one memory storing instructions that, when executed by the at least one processor, cause the UE at least to:
receive, from a first network node associated with the first cell, configuration information for requesting cell access related information with respect to at least one of the first cell and the second cell, the first cell being controlled by the first network node and the second cell being controlled by a second network node;
determine, based at least on the configuration information, uplink power for transmitting a first request message requesting the cell access related information with respect to the at least one of the first cell and the second cell; and
transmit, to the first network node, the first request message using the determined uplink power.

2. The UE according to claim 1, wherein the uplink power for transmitting the first request message is determined further based on at least one uplink power control parameter and/or at least one reference signal associated with the first and/or the second cell included in the configuration information.

3. The UE according to claim 1, wherein the uplink power for transmitting the first request message is determined based on a path loss for the first cell derivable from the configuration information.

4. The UE according to claim 1, wherein the uplink power for transmitting the first request message is determined based on a path loss for the first cell determined based on a first reference signal received from the first network node, and/or a second reference signal received from the second network node, as included in the configuration information.

5. The UE according to claim 4, wherein the first reference signal and the second reference signal comprise different transmitting power parameters or patterns, and wherein the UE is further caused to determine the path loss by at least one of the following:
selecting, as the path loss for determining the uplink power, a greater one of a first path loss determined based on the first reference signal and a second path loss determined based on the second reference signal,
determining an average path loss of the first path loss and the second path loss, and applying, based on a predefined rule included in the configuration information, a combining function to smooth the first path loss and the second path loss.

6. The UE according to claim 1, wherein the UE is further caused to receive the cell access related information with respect to the at least one of the first cell and the second cell, and optionally, to transmit, to the second network node, a second request message requesting the cell access related information with respect to the at least one of the first cell and the second cell based on the configuration information.

7. The UE according to claim 1, wherein the cell access related information comprises a first type System Information Block, SIB1, of the first cell and/or the second cell, wherein the UE is further caused to receive, from the first network node, the SIB1 of at least one of the first cell and the second cell, and, optionally, wherein the UE is further caused to receive the SIB1 of at least one of the first cell and the second cell from the second network node.

8. The UE according to claim 1, wherein the first request message is a single request requesting the cell access related information with respect to the first cell and the second cell.

9. The UE according to claim 8, wherein the cell access related information comprises a difference of the SIB1 related to the first cell or the second cell, wherein the UE is further caused to receive, from the first network node:
the SIB1 of the first cell or the difference of the SIB1 related to the first cell with respect to the second cell, or
the SIB1 of the first cell and the SIB1 of the second cell, or
the difference of the SIB1 related to the first cell with respect to the second cell and the SIB1 of the second cell.

10. The UE according to claim 9, wherein the UE is further caused to receive the SIB1 of the second cell from the second network node in case that the UE receives from the first network node the SIB1 of the first cell or the difference of the SIB1 related to the first cell with respect to the second cell.

11. The UE according to claim 1, wherein the configuration information comprises at least one of: at least one uplink power control parameter for transmitting the first request message, a set of downlink reference signals associated with the first and/or the second cell for uplink power control, resource information relating to Physical Random-Access Channel, PRACH, for transmitting the first request message, and information for monitoring transmissions of the cell access related information with respect to the first and/or the second cell.

12. The UE according to claim 7, wherein the configuration information comprises at least one of: a first dedicated configuration for requesting the SIB1 of the first network node, a second dedicated configuration for requesting the SIB1 of the second network node, and a shared configuration for requesting the SIB1 of the first network node and the SIB1 of the second network node.

13. The UE according to claim 1, wherein the configuration information comprises at least one of: a first configuration for requesting the cell access related information with respect to the first cell, a second configuration for requesting the cell access related information with respect to the second cell, and a third configuration for requesting the cell access related information with respect to the first cell and the second cell.

14. The UE according to claim 13, wherein at least one of the first configuration, the second configuration and the third configuration comprises at least one of the following:
at least one uplink power control parameter for transmitting the first request message, a set of downlink reference signals associated with the first and/or the second cell for uplink power control,
resource information relating to Physical Random-Access Channel, PRACH, for transmitting the first request message, and
information for monitoring transmissions of the cell access related information with respect to the first and/or the second cell, and wherein, optionally, the resource information comprises at least one PRACH preamble associated with the first request message requesting for at least one of the cell access related information with respect to the first cell, the cell access related information with respect to the second cell, and the cell access related information with respect to the first cell and the second cell.

15. The UE according to claim 1, wherein the first network node is associated with the first radio access technology and the second network node is associated with the second radio access technology, the first radio access technology sharing spectrum with the second radio access technology.

16. The UE according to claim 1, wherein the UE is further caused to identify the first cell based on a Synchronization Signal Block, SSB, transmitted from the first network node, and/or wherein the UE is further caused to select or re-select the first cell based on the SSB transmitted from the first network node.

17. The UE according to claim 1, wherein the configuration information comprises monitoring occasions for transmission of the cell access related information with respect to the first and/or the second cell, and wherein the UE is further caused to determine, based on the configuration information, common monitoring occasions for transmission of the cell access related information with respect to the first and the second cell in response to determination that the monitoring occasions for transmission of the cell access related information with respect to the first cell are aligned with the monitoring occasions for transmission of the cell access related information with respect to the second cell.

18. The UE according to claim 17, wherein the UE is further caused to receive the cell access related information with respect to the at least one of the first cell and the second cell in the determined common monitoring occasions.

19. The UE according to claim 1, wherein the configuration information comprises monitoring occasions for transmission of the cell access related information with respect to the first and/or the second cell, and wherein the UE is further caused to determine, based on the configuration information, the monitoring occasions for transmission of the cell access related information with respect to the first cell and/or the second cell, the monitoring occasions for transmission of the cell access related information with respect to the first cell are different than the monitoring occasions for transmission of the cell access related information with respect to the second cell.

20-21. (canceled)

22. A method of a User Equipment, UE, that supports communication with a first cell using a first radio access technology and with a second cell using a second radio access technology different from the first radio access technology, the method comprising:
receiving, from a first network node associated with the first cell, configuration information for requesting cell access related information with respect to at least one of the first cell and the second cell, the first cell being controlled by the first network node and the second cell being controlled by a second network node;
determining, based at least on the configuration information, uplink power for transmitting a first request message requesting the cell access related information with respect to the at least one of the first cell and the second cell; and
transmitting, to the first network node, the first request message using the determined uplink power.

23. (canceled)
